(19) United States
(12) Patent Application Publication
(10) Pub. No.: US 2018/0343479 A1
(43) Pub. Date: Nov. 29, 2018

(54) UNIVERSAL OPTIMIZED CONTENT CHANGE

(71) Applicant: OpenTV, Inc., San Francisco, CA (US)

(72) Inventor: Martin Gibson, San Francisco, CA (US)

(21) Appl. No.: 15/607,126

(22) Filed: May 26, 2017

(51) Int. Cl. H04N 21/25; H04N 21/462

(52) U.S. Cl. CPC H04N 21/251; H04N 21/40; H04N 21/4622

(57) ABSTRACT

Example embodiments provide a system and method for optimizing content changes (e.g., channel changes). A digital receiver monitors, in real-time, user interactions with a content access page presented on a viewing device. Based on the real-time user interactions, the digital receiver determines a plurality of content of interest, and triggers acquisition of metadata for the plurality of content of interest determined based on the real-time user interactions. The metadata comprise preconditions for the display of a selected piece of content. The digital receiver fetches the metadata for one or more of the plurality of content of interest. The metadata for the one or more of the plurality of content of interest is then cached and is immediately available in response to a selection, for viewing, of a piece of content associated with the metadata in the cache.

### FIELD

The present disclosure generally relates to machines configured to the technical field of special-purpose machines that facilitate optimizing content changes (e.g., channel change) including computerized variants of such special-purpose machines and improvements to such variants, and to the technologies by which such special-purpose machines become improved compared to other special-purpose machines that facilitate optimizing content changes. In particular, the present disclosure addresses systems and methods for configuring a device to optimize content change based on navigational context and regardless of a delivery channel.

### BACKGROUND

Conventionally, during a channel change, certain information needs to be obtained before requested content (e.g., program, movie, show) is rendered and displayed. For example, in over-the-top (OTT) channel changes, one or more manifest files and licenses need to be obtained. Similarly, in broadcast television, programming tables must be accessed. In some cases, there are propriety solutions that focus on very specific elements. For example, for IPTV fast channel change, a completely different second stream may be used to obtain information and start rendering while the system is waiting to join an actual multicast.

For broadcast technology, conventional systems solve a very narrow problem of how to ensure that the system can tune and present video on a satellite network in a faster way. In some of these conventional systems, the system involves working with an end customer—the broadcaster—to rearrange their channels to allow predictive channel decode to happen. As such, the channels need to be interleaved in a correct way. A disadvantage of this type of system is that the system takes encryption and spreads it across the system which exposes weaknesses in content protection. For instance, with ultra-high-definition (UHD), high value content typically sits in a secure media path without direct access.

However, conventional systems expose that high value content when attempting to speed up channel changes.

### BRIEF DESCRIPTION OF DRAWINGS

Various ones of the appended drawings merely illustrate example embodiments of the present invention and cannot be considered as limiting its scope.

FIG. 1 is a diagram illustrating an example environment for optimizing content changes.

FIG. 2 is a block diagram illustrating an example embodiment of components within a digital receiver in accordance with an example embodiment.

FIG. 3 is a flow diagram of an example method for optimizing content change.

FIG. 4A and FIG. 4B are flow diagrams of example methods for determining content of interest in accordance with example embodiments.

FIG. 5 is a flow diagram of an example method for prefetching metadata in accordance with an example embodiment.

FIG. 6 is a diagrammatic representation of a machine in an example form of a computing system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example embodiments described herein provide systems and methods for optimizing content changes, such as a channel change. In example embodiments, the system uses navigational context (e.g., the way a user is interacting with the application) to identify content of (potential) interest to a viewer. The system then prefetches metadata for the content of interest from a content provider and stores the metadata to local cache. The metadata comprises preconditions for rendering and display of a piece of content that include a minimum set of data that a system can obtain without having to decrypt the content or expose the content. In example embodiments, the metadata does not include any portion of the actual content (e.g., first 30 seconds of the content). For example, the metadata may include one or more of a manifest (e.g., describing layout of the content/codecs used), a playlist (e.g., showing one or more profiles), or a license (e.g., allowing for extraction of encryption or encryption key and enforces usage rules) for each piece of content; one or more program tables (e.g., program association table (PAT), program map table (PMT)); or any other data that is a part of preconditions for rendering and display a piece of content (e.g., television show, movie, broadcast or streamed event (e.g., sports event, music event)). If the viewer subsequently selects the content for viewing, the system accesses the metadata from the cache instead of having to, at that point, obtain the metadata from the content provider.

As a result, one or more of the methodologies described herein facilitate solving the technical problem of optimizing content change (e.g., reducing time for a change in channel or loading of new content) regardless of the delivery channel—whether the content is broadcast (e.g., IPTV and multicast) or over-the-top (OTT). As such, example embodiments are capable of handling a mixture of different content from different content sources (e.g., broadcast, OTT, home network). The methodologies include monitoring, in real-time, user interactions with a content access page. Based on the real-time user interactions, a plurality of content of interest is determined and acquisition of metadata for the plurality of content of interest determined based on the real-time user interactions is triggered. The metadata comprise preconditions for the display of a selected piece of content. The metadata for one or more of the plurality of content of interest is fetched requested, obtained, acquired, received). The fetched metadata is then cached and is immediately available in response to a selection, for viewing, of a piece of content associated with the metadata in the cache. By using embodiments of the present invention, the time needed to change content (e.g., start playing a new selected piece of content) is reduced. Accordingly, one or more of the methodologies discussed herein improves upon latency during content changes. It is noted that content changes includes a selection of a piece of content for viewing (e.g., from a content access page such as a favorites grid or via a programming guide) as well as channel changes (e.g., linear channels changes).

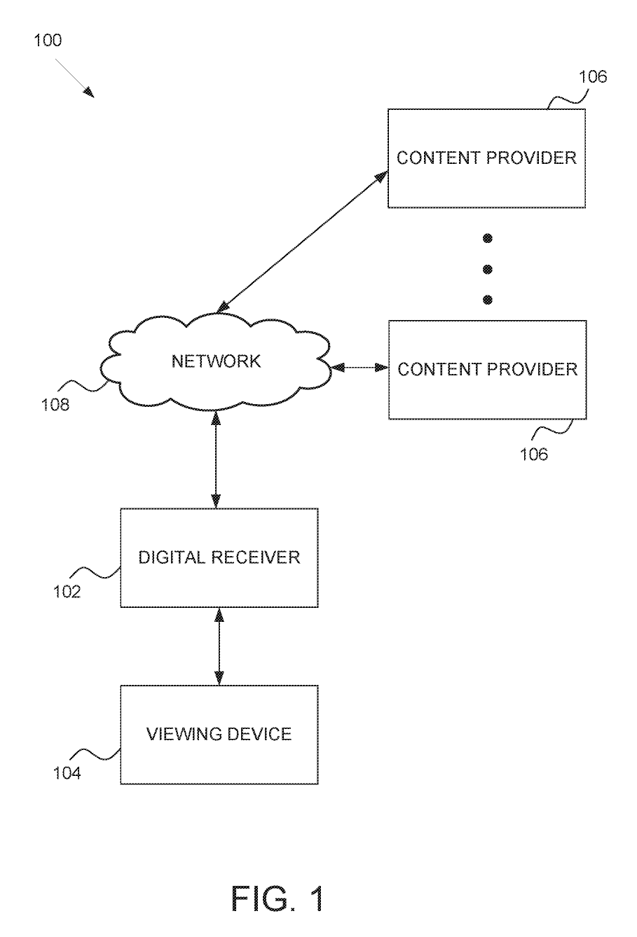

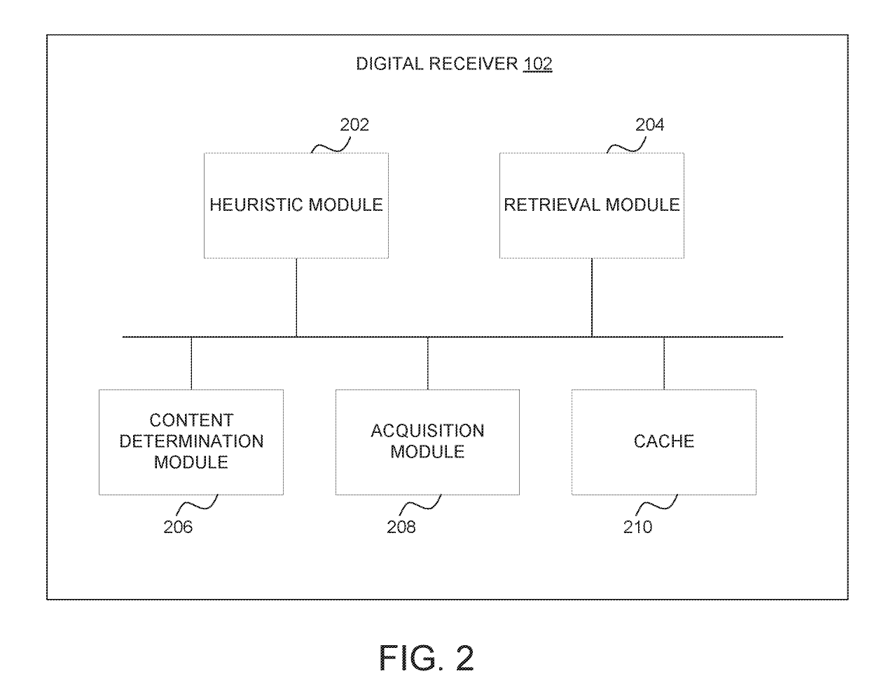

With reference to FIG. 1, an embodiment of an example environment 100 that enables optimizing content changes (e.g., reducing latency during channel changes or selection of a piece of content for viewing) is shown. In example embodiments, a digital receiver 102 of a user provides access to digital content and manages content change operations. In one embodiment, the digital receiver 102 is a set-top box. The digital receiver 102 is coupled to a viewing device 104 (e.g., a television or monitor) on which the user can view the digital content. In some embodiments, the digital receiver 102 (e.g., operations of the digital receiver 102) may be combined with the viewing device 104 (e.g., a smart television, a tablet, or smartphone). The operations of the digital receiver 102 will be discussed in more detail in connection with FIG. 2 below.

In some embodiments, the content providers 106 provides content data, over a network 108 to the digital receiver 102 for display on the viewing device 104. In example embodiments, each content provider 106 comprises a third party service (e.g., Netflix, Hulu, YouTube, Amazon,) that stores and provides content, such as, for example but not limited to, over-the-top (OTT) content, video-on-demand (VOD) content, Internet content, or broadcast content to the digital receiver 102 via the network 108. The content comprises text, images, audio, and/or video content (e.g., movies, television shows, videos). In some embodiments, the content providers 106 provide their content through a content distribution system (not shown) that then provides the content over the network 108 to the digital receiver 102.

One or more portions of the network 108 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, a satellite network, a cable network, a broadcast network, another type of network, or a combination of two or more such networks. Any one or more portions of the network 108 may communicate information via a transmission or signal medium. As used herein, “transmission medium” refers to any intangible (e.g., transitory) medium that is capable of communicating (e.g., transmitting) instructions for execution by a machine by one or more processors of such a machine), and includes digital or analog communication signals or other intangible media to facilitate communication of such software.

It is noted that the environment 100 shown in FIG. 1 is merely an example. For instance, any number of content providers 106 may be embodied within the environment 100. Additionally, some components of the environment 100 may be combined. For example, the functions of the digital receiver 102 may be embodied within the viewing device 104 to form a single device, such as a smart television, tablet, smartphone, or any other device that is capable of obtaining, rendering, and displaying content.

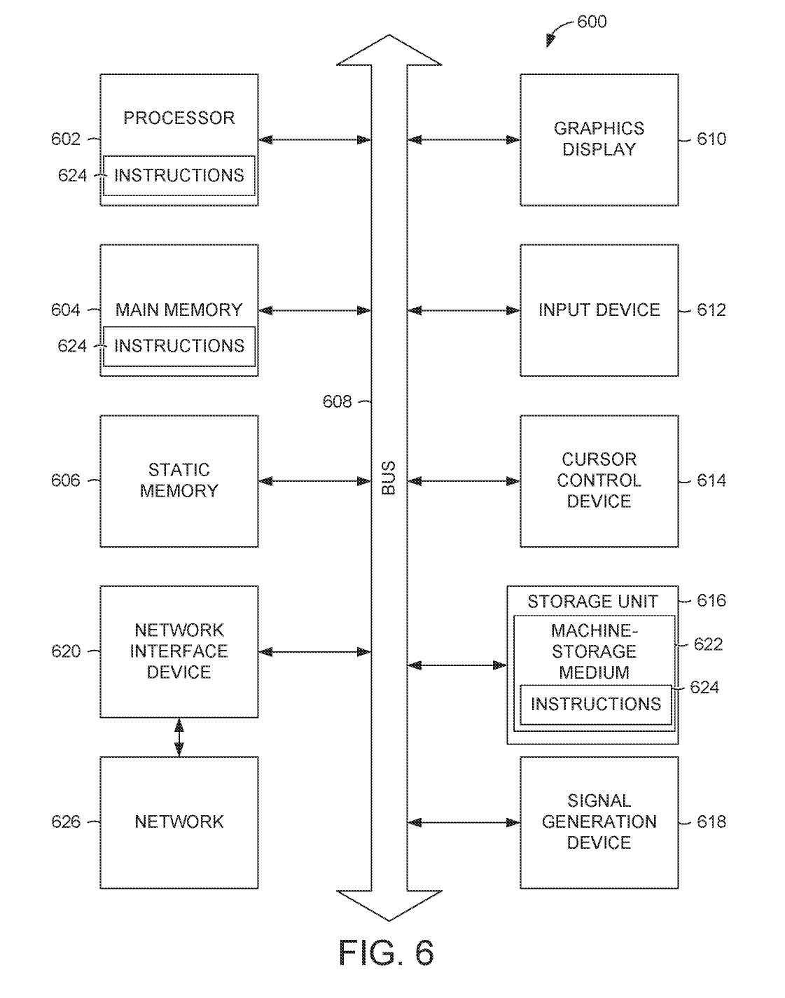

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines. Moreover, any two or more of the systems or machines illustrated in FIG. 1 may be combined into a single system or machine, and the functions described herein for any single system or machine may be subdivided among multiple systems or machines.

FIG. 2 is a block diagram illustrating an example embodiment of components within the digital receiver 102 in accordance with an example embodiment. In example embodiments, the digital receiver 102 manages and runs applications, uses navigational context to determine content of interest for a user, and uses the determined content of interest to prefetch metadata for content prior to a user selecting the content in order to provide faster content change (e.g., faster rendering and display of the selected content). To enable these operations, the digital receiver 102 comprises a heuristic module 202, a retrieval module 204, a content determination module 206, an acquisition module 208, and a cache 210 all of which may be configured to communicate with each other (e.g., over a bus, shared memory, or a switch). In example embodiments, some of the modules are embodied within an application operating on the digital receiver 102 (e.g., the heuristic module 202 and retrieval module 204), while other modules are embodied within an operation system (OS) (e.g., the content determination module 206 and the acquisition module 208). The digital receiver 102 also comprises drivers which enable one or more hardware devices to communicate with the OS in order to control/operate components of the digital receiver 102.

The heuristics module 202 manages determination of a user's interests in content based on a current navigation context. In example embodiments, the heuristics module 202 monitors, in real time, user interactions with a content access page, and detects how the user is navigating the content access pages (e.g., a program or channel list). The heuristics module 202 then dynamically determines what may be the likely choices for channel changes (e.g., programs a user may select for viewing) based on a current position on the content access page and navigational inputs. For example, a user may be navigating a linear list of channels/programs (e.g., an electronic programming guide). If the user is navigating in a particular direction (e.g., scrolling down along the list), the heuristics module 202 determines a direction heuristic that indicates the content of interest is a next n number of channels (e.g., content or content programs on these channels) in a downward direction on the linear list. For instance, the determined content of interest is the next five channels down from a current channel that the user is presently on in the linear list. Once the user has scrolled past these five channels, then the heuristic module 202 removes interests in these five channels and selects the next five channels as the current content of interest. While the navigational input is discussed, in the example, as a downward input, the navigational input can be any directional input for a linear list (e.g., horizontal to the left, horizontal to the right, up, and down) or even for a grid (e.g., any diagonal direction).

In other embodiments, the content access page comprises a favorites grid (e.g., a saved watchlist) or a recommended list of content. In these embodiments, the heuristics module 202 may determine that every piece of content on the favorites grid or recommended list is a content of interest. Alternatively, the heuristics module 202 may determine that a top number top 15) of pieces of content from the favorites grid or recommended list are the content of interest based on settings (e.g., default or adjustable settings). For example, the top number of pieces of content may be based on the most recently added content, most highly rated content, or other parameters used to order the content on the content access page.

Other forms of heuristics may be determined by the heuristics module 202. For example, in a “continue watching” selection, the heuristics module 202 expresses an interest in the first N rank ordered by preference (e.g., most recently watched). In a recommendations result example, the heuristics module 202 expresses an interest in the first N recordings with the highest recommendation ranking. In yet another example, if the user is browsing a series, the heuristics module 202 expresses an interest in the next N episodes of the series.

The retrieval module 204 triggers the retrieval of metadata for the content of interest. Taking the content of interest determined by the heuristics module 202, the retrieval module 204 triggers the content determination module 206 and the acquisition module 208 to perform their operations. In embodiments where the heuristics module 202 and the retrieval module 204 are embodied within an application and the content determination module 206 and the acquisition module 208 are embodied within the OS, the retrieval module 204 “expresses interest” in content by transmitting a request or instructions to the OS (e.g., transmitting a request indicating the content of interest by providing a list of content source URLs). The OS may add the content of interest from the request into a cache in the order that it is received (e.g., last request is at a top of the cache and has the most priority). In some embodiments, the retrieval module 204 transmits the request (e.g., comprising content source URLs) to the content determination module 206. In some embodiment (e.g., an embodiment where the heuristics module 202, the content determination module 206, and the acquisition module 208 are embodied within a same application or system), the retrieval module 204 may be optional or not needed. Instead, the heuristics module 202 indicates (e.g., expresses) the content of interest to the content determination module 206 and/or the acquisition module 208 directly.

The content determination module 206 determines a delivery channel associated with the content of interest (e.g., whether the indicated content of interest is broadcast (multicast) or OTT (unicast) content). Based on the determination, different metadata is obtained from different content providers 106 by the acquisition module 208 for the indicated content of interest. As such, the content of interest can, in some embodiments, comprise a mix of both multicast (e.g., broadcast) and unicast (e.g., OTT) content.

In embodiments where the indicated content of interest is unicast or OTT content (e.g., the URL is for OTT content), for each piece of OTT content of interest, the acquisition module 208 fetches (e.g., obtains, retrieves, accesses, or receives) a basic level of static information as metadata. In one embodiment, the acquisition module 208 requests the metadata from a server (e.g., from a database of the content provider 106). In example embodiments, the OTT metadata comprise a manifest, a variable playlist, and a license for each piece of content of interest. The manifest may state whether the piece of content is live or not. If the piece of content is live, then the variable playlist will refresh (e.g., every 30 seconds), so that it is continuously up-to-date. However, if the content is not live (e.g., video-on-demand (VoD)), no refresh is needed. The fetched metadata is then stored to the cache 210 web cache).

In embodiments where the content is multicast or broadcast content (e.g., the URL, is for a broadcast event), the acquisition module 208 obtains the metadata in an opportunistic way. In one embodiment, the content of interest from the request is placed in a priority queue where a most recent request is the highest priority. In some cases, the digital receiver 102 may be playing content, recording content, and performing other actions. Therefore, the acquisition module 208, in the background, performs a lookup to determine, for a piece of content (and according to priority), a transport stream identifier (TSID) with which tuning parameters are determined (e.g., through a look up using the TSID). The tuning parameters identify whether the piece of content is cable, satellite, ATSC (Advanced Television Systems Committee), and so forth. The acquisition module 208 then makes a request for a data connection (e.g., request for resources). Assuming the data connection is available (e.g., a tuner of a correct type and a demultiplexer are available), the acquisition module 208 then tunes to the correct tuning parameters and starts acquiring the metadata. In example embodiments, the acquisition module 208 extracts one or more tables such as, for example, a program map table (PMT), a program association table (PAT), a conditional access table (CAT), or a network information table (NIT). In some embodiments, the acquisition module 208 fetches metadata for all content (e.g., all URLs) on a same transport stream (e.g., sharing a TSID). Once the metadata is acquired, the acquisition module 208 yields the resources, and stores the metadata to the cache 210.

Any one or more of the components (e.g., modules) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. The digital receiver 102 may comprise other components not pertinent to example embodiments that are not shown or discussed.

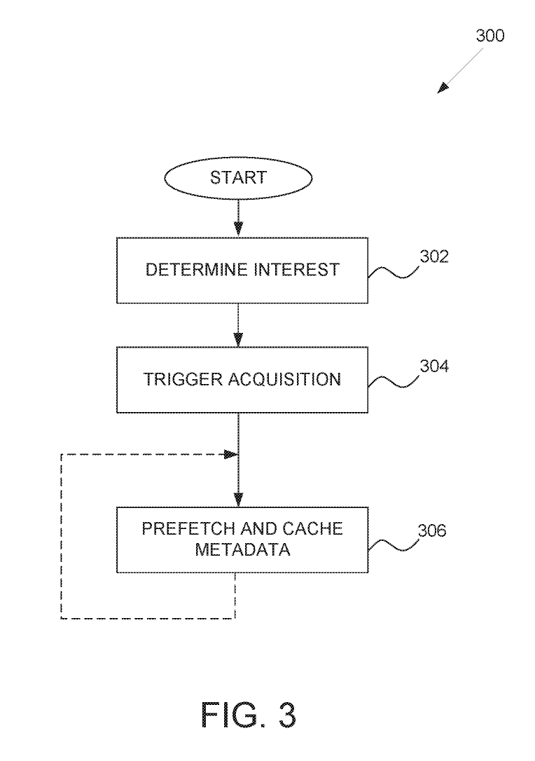

FIG. 3 is a flow diagram of an example method 300 for optimizing content change in accordance with an example embodiment. Operations in the method 300 may be performed by the receiver device 102 using one or more modules described above with respect to FIG. 2. Accordingly, the method 300 is described by way of example with reference to the receiver device 102. However, it shall be appreciated that at least some of the operations of the method 300 may be deployed on various other hardware configurations or be performed by similar components residing elsewhere in the network environment 100. Therefore, the method 300 is not intended to be limited to the receiver device 102. The method 300 occurs in real-time as the user is navigating a content access page (e.g., electronic programming guide, favorites grid, recommendation list).

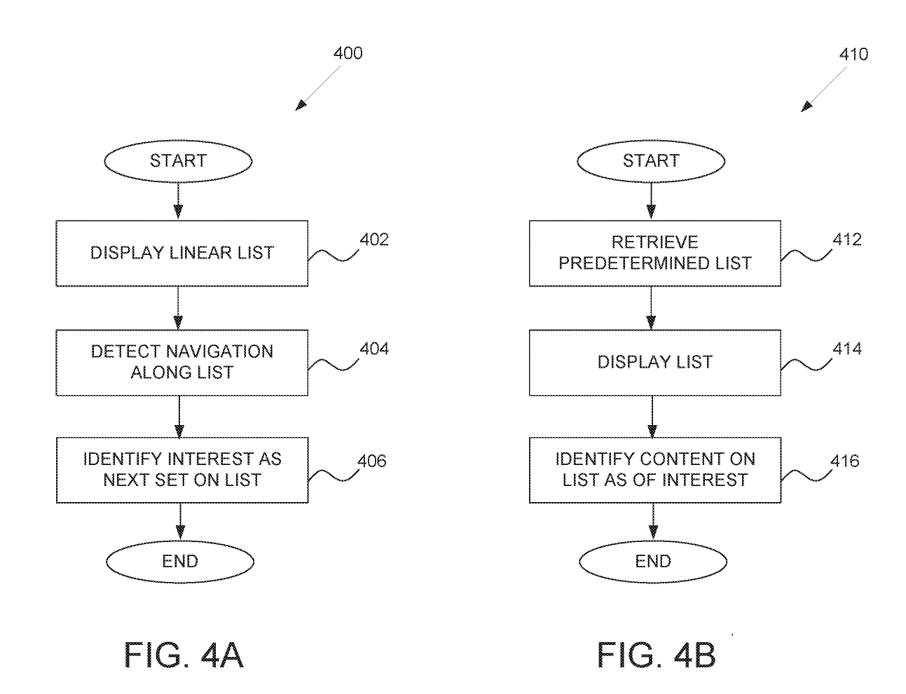

In operation 302, the heuristic module 302 determines potential interest of the user based on navigational context. Accordingly, the heuristic module 202 monitors, in real time, user interaction with a content access page to detect navigational inputs of the user. The monitoring indicates where the user is currently on a content access page (e.g., a programming guide; favorites grid or recommended list; watchlist) and where the user is likely to navigate to next. Operation 302 will be discussed in further detail in connection with FIG. 4A and FIG. 4B.

In operation 304, the retrieval module 204 triggers retrieval or acquisition of metadata by indicating the content of (potential) interest for which metadata should be fetched (also referred to as “prefetched”). In example embodiments, the retrieval module 204 takes the content of interest determined by the heuristics module 202, and triggers the content determination module 206 and the acquisition module 208 to perform their operations. In example embodiments, the retrieval module 204 transmits a message (e.g., request, instructions) indicating the content of interest (e.g., URLs for the content of interest) to the content determination module 206 and/or the acquisition module 208. In some cases, the retrieval module 204 transmits a message to the OS with instructions to prefetch and cache the metadata for the content of interest.

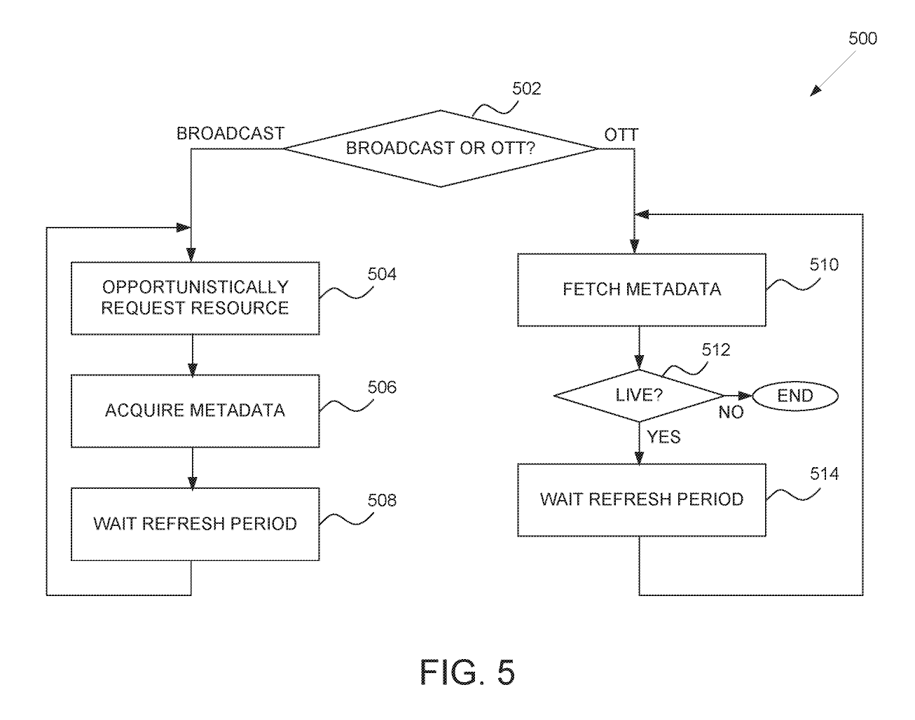

In operation 306, the metadata is acquired (e.g., prefetched) and cached by the acquisition module 208. Operation 306 will be discussed in further detail in connection with FIG. 5 below.

Referring now to FIG. 4A and FIG. 4B, flow diagrams of example methods 400 and 410 (e.g., detailed versions of operation 302) for determining content of (potential) interest in accordance with example embodiments are shown. Operations in the methods 400 and 410 may be performed by the receiver device 102 using various modules, including the heuristic module 202, described above with respect to FIG. 2. Accordingly, the methods 400 and 410 are described by way of example with reference to the receiver device 102. However, it shall be appreciated that at least some of the operations of the methods 400 and 410 may be deployed on various other hardware configurations, be performed by similar components residing elsewhere in the network environment 100, or be performed by other modules. Therefore, the methods 400 and 410 are not intended to be limited to the receiver device 102.

100331 The method 400 of FIG. 4A describes operations for determining content of interest for embodiments whereby the content access page is a linear list of content (e.g., an electronic program guide) being viewed and navigated by the user. Accordingly, in operation 402, the linear list is displayed to user by the digital receiver 102. As such, the digital receiver 102 transmits data representing the linear list to the viewing device 104 causing the viewing device to display the linear list.

In operation 404, navigation along the linear list is monitored and detected by the digital receiver 102 (e.g., by the heuristic module 202). For example, the user may be scrolling up along the linear list to view the various content playing on each channel. The digital receiver 102 (e.g., heuristics module 202) detects where the user is on the linear list and also detects in which direction the navigation is occurring (e.g., scrolling up, down, right, left).

In operation 406, the heuristic module 202 identifies the content of interest. In example embodiments, the content of interest is determined to be a next set of content (e,g., next five channels or programs) on the linear list in the same detected navigational direction. As, the user continues to scroll along the linear list, the content of interest will dynamically change. For example, once the user has scrolled past the initial five channels that were determined to be the content of interest, the heuristic module 202 removes these five channels and selects the next five channels as the current content of interest. It is noted that while a linear list is discussed, the operations of FIG. 4A may be applied to a grid whereby the navigational directions can include up, down, left, right, and diagonally.

The method 410 of FIG. 4B describes operations for determining content of interest for embodiments whereby the content access page comprises a predetermined list of content being viewed and navigated by the user. The predetermined list of content may comprise, for example, a watchlist established by the user, a favorites grid/list, or a list of recommended content. Accordingly, in operation 412, the predetermined list is retrieved, from a coupled datastore, by the digital receiver 102. For example, the digital receiver 102 determines which user is viewing content (e.g., via the user logging in or otherwise identifying themselves to the digital receiver). The predetermined list for the identified user is then retrieved from the datastore.

The predetermined list is then displayed to user by the digital receiver 102 in operation 414. In example embodiments, the digital receiver 102 transmits data representing the predetermined list to the viewing device 104 causing the viewing device to display the predetermined list. It is noted that while example embodiments discuss a list, the content on the predetermined list may be displayed in any manner (e.g., in a grid format, randomly).

In some of these embodiments, since the user has already indicated interest in the content on the predetermined list (e.g., the watchlist or favorites grid), the heuristics module 202 “knows” all the content on the predetermined list are content of interest. Therefore, the heuristic module 202 identifies, for example, every piece of content on the predetermined list as the content of interest in operation 416. In other embodiments, the heuristic module 202 may select only a top number (e.g., based on ratings, based on when added to the list) of content on the predetermined list, or a next number (e.g., next 20) of content based on where the user is currently on the predetermined list and a navigational direction the user is scrolling in.

FIG. 5 is a flow diagram of an example method 500 (e.g., detailed version of operation 306) for prefetching metadata in accordance with an example embodiment. Operations in the method 500 may be performed by the receiver device 102, using one or more modules described above with respect to FIG. 2, including the content determination module 206 and the acquisition module 208. Accordingly, the method 500 is described by way of example with reference to the receiver device 102. However, it shall be appreciated that at least some of the operations of the method 500 may be deployed on various other hardware configurations or be performed by similar components residing elsewhere in the network environment 100. Therefore, the method 500 is not intended to be limited to the receiver device 102.

In operation of 502, the content determination module 206 determines a delivery channel associated with each piece of content of interest. Accordingly, the content determination module 206 determines whether the indicated content of interest is multicast (e.g., broadcast) or unicast (e.g., OTT) content. Based on the determination, different metadata is obtained in different manners by the acquisition module 208 for the indicated content of interest. It is noted that a list of content of interest may comprise both multicast and unicast content. Example embodiments are content agnostic and can manage prefetching metadata for any form of content delivery (e.g., can have a blend of broadcast, OTT, VoD, and favorites from home network); thus providing universal optimized content change.

In embodiments where the content is multicast or broadcast content, the acquisition module 208 obtains the metadata in an opportunistic way. In operation 504, the acquisition module 208 opportunistically requests resources. In example embodiments, the acquisition module 208 performs a lookup to determine a transport stream identifier (TSID) for a piece of content of interest. Using the TSID, tuning parameters are looked up by the acquisition module 208. The acquisition module 208 then makes a request for a data connection (e.g., request for resources such as tuners and demultiplexers). In alternative embodiments, one or more tuners and demultiplexers may be reserved for prefetching operations.

In operation 506, metadata is acquired by the acquisition module 208 from the content provider 106. Once the resources (e.g., a tuner and a demultiplexer) are available, the acquisition module 208 tunes to the correct tuning parameter and starts acquiring the metadata. In example embodiments, the acquisition module 208 extracts (e.g., accesses, retrieves, obtains, receives) one or more tables such as, for example, a program map table (PMT), a program association table (PAT), a conditional access table (CAT), or a network information table (NIT). In some embodiments, the acquisition module 208 picks up metadata for some or all content (or content of interest) on a same transport stream (e.g., sharing a TSID). Once the metadata is acquired, the acquisition module 208 yields the resources, and stores the metadata to the cache 210. Operation 506 may be repeatedly performed for each piece of content of interest.

In operation 508, the acquisition module 208 waits a broadcast refresh period before returning to operation 504 to refresh the cache 210. Refreshing the cache 210 ensures that there is more or most current information available for the content of interest. In example embodiments, the metadata (e.g., one or more of the tables) has an expiry time. For example, assume a program finishes at 5:59 and the next program starts at 6:00, an event boundary may cause tables to change. As such, previous tables may no longer be valid, so the acquisition module 208 will want to acquire the updated metadata. As a result, when an actual connection to a piece of content is established (e.g., in order to view the piece of content), the most current information (e.g., the metadata) is already in the cache 210. In some examples, the caching saves 0.5 seconds for a piece of multicast or broadcast content.

In embodiments where the indicated content of interest is unicast or OTT content, for each piece of content of interest, the acquisition module 208 fetches (e.g., obtains, retrieves, accesses, or receives) metadata (e.g., from a database of a server of the content provider 106) in operation 510. In example embodiments, the OTT metadata comprises a manifest, a variable playlist, and a license for each piece of content of interest. The fetched metadata is then stored to the cache 210 (e.g., web cache). In some examples, the caching saves between 0.5-0.7 seconds for a piece of unicast or OTT content. Operation 510 may be repeatedly performed for each piece of content of interest.

The manifest may state whether the piece of content is live or not. As such, in operation 512, the acquisition module 208 determines whether the piece of content is live or not by examining the manifest. If the piece of content is live, then in operation 514, the acquisition module 208 waits a refresh period before refreshing the cache 210 by returning to operation 510. The refresh occurs (e.g., every 30 seconds), so that the metadata is continuously up-to-date. For example, the manifest is refreshed on live content so it shows time offsets for the segments. However, if the content is not live (e.g., video-on-demand (VoD), catch-up, start-over, NPVR)), no refresh is needed.

FIG. 6 is a block diagram illustrating components of a machine 600, according to some example embodiments, able to read instructions 624 from a machine-storage medium 622 and perform any one or more of the methodologies discussed herein, in whole or in part. Specifically, FIG. 6 shows the machine 600 in the example form of a computer device (e.g., a computer) within which the instructions 624 (e.g., software, a program, an application, an apples, an app, or other executable code) for causing the machine 600 to perform any one or more of the methodologies discussed herein may be executed, in whole or in part.

For example, the instructions 624 may cause the machine 600 to execute the flow diagrams of FIGS. 3-5. The instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. The machine 600 may be a server computer, a client computer, a personal computer (PC), a tablet computer, a laptop computer, a netbook, a set-top box (e.g. STB), a personal digital assistant (PDA), a cellular telephone, a smartphone, a web appliance, a network router, a network switch, a network bridge, a power adapter, or any machine 600 capable of executing the instructions 624, sequentially or otherwise, that specify actions to be taken by that machine 600. Further, while only a single machine 600 is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, a signal generation device 618 (e.g., a sound card, an amplifier, a speaker, a headphone jack, or any suitable combination thereof), and a network interface device 620.

The storage unit 616 includes the machine-storage medium 622 on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-storage media 622 (e.g., tangible and non-transitory machine-readable media).

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” or “signal medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium 622 or in a signal medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 602 or a group of processors 602) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules.

### EXAMPLES

Example 1 is a method for optimizing content change. The method comprises monitoring, in real-time using one or more hardware processors, user interactions with a content access page presented on a viewing device; based on the real-time user interactions, determining, by one or more hardware processors, a plurality of content of interest; triggering acquisition of metadata for the plurality of content of interest determined based on the real-time user interactions, the metadata comprising preconditions for the display of a selected piece of content; fetching the metadata for one or more of the plurality of content of interest; and caching the metadata for the one or more of the plurality of content of interest, the metadata in the cache being immediately available in response to a selection of a piece of content associated with the metadata in the cache for viewing.

In example 2, the subject matter of example 1 can optionally include wherein the monitoring comprises detecting a navigational input on the content access page; and the determining the plurality of content of interest comprises selecting a next n number of content in a direction of the navigational input as the plurality of content of interest,

In example 3, the subject matter of examples 1-2 can optionally include wherein the content access page comprises a favorites grid; and the determining the plurality of content of interest comprises selecting every content on the favorites grid as the plurality of content of interest.

In example 4, the subject matter of examples 1-3 can optionally include wherein the content access page comprises a favorites grid; and the determining the plurality of content of interest comprises selecting a top number of content on the favorites grid as the plurality of content of interest.

In example 5, the subject matter of examples 1-4 can optionally include wherein the metadata comprises one or more of a manifest, a playlist, a license, a program map table (PMT), a program association table (PAT), a conditional access table (CAT), or a network information table (NIT).

In example 6, the subject matter of examples 1-5 can optionally include wherein the triggering acquisition of metadata for the plurality of content of interest comprises providing a list of content of interest URLs to an operating system (OS).

In example 7, the subject matter of examples 1-6 can optionally include wherein the fetching of the metadata for the plurality of content of interest comprises opportunistically requesting resources for establishing a data connection; in response to establishing the data connection, accessing metadata based on tuning parameters determined for one of the plurality of content of interest; and extracting metadata for the one of the plurality of content of interest.

In example 8, the subject matter of examples 1-7 can optionally include extracting metadata for any of the plurality of content of interest having a same transport stream identifier (TSID) as that of the one of the plurality of content of interest.

In example 9, the subject matter of examples 1-8 can optionally include determining from a manifest that a piece of over-the-top (OTT) content of interest of the plurality of content of interest is live; in response to the determining that the piece of OTT content of interest is live, waiting a manifest refresh period of time before fetching updated metadata for the piece of content of interest; and fetching the updated metadata after waiting the manifest refresh period of time.

In example 10, the subject matter of examples 1-9 can optionally include waiting a broadcast refresh period of time before fetching updated metadata for a piece of broadcast content of the plurality of content of interest; and fetching the updated metadata after waiting the broadcast refresh period of time.

Example 11 is a system for optimizing content changes. The system includes one or more hardware processors and a memory storing instructions, that when executed by the one or more hardware processors, cause the one or more hardware processors to perform operations comprising monitoring, in real-time user interactions with a content access page presented on a viewing device; based on the real-time user interactions, determining a plurality of content of interest; triggering acquisition of metadata for the plurality of content of interest determined based on the real-time user interactions, the metadata comprising preconditions for the display of a selected piece of content; fetching the metadata for one or more of the plurality of content of interest; and caching the metadata for the one or more of the plurality of content of interest, the metadata in the cache being immediately available in response to a selection of a piece of content associated with the metadata in the cache for viewing.

In example 12, the subject matter of example 11 can optionally include wherein the monitoring comprises detecting a navigational input on the content access page; and the determining the plurality of content of interest comprises selecting a next n number of content in a direction of the navigational input as the plurality of content of interest.

In example 13, the subject matter of examples 11-12 can optionally include wherein the content access page comprises a favorites grid; and the determining the plurality of content of interest comprises selecting every content on the favorites grid as the plurality of content of interest.

In example 14, the subject matter of examples 11-13 can optionally include wherein the content access page comprises a favorites grid; and the determining the plurality of content of interest comprises selecting a top number of content on the favorites grid as the plurality of content of interest.

In example 15, the subject matter of examples 11-14 can optionally include wherein the triggering acquisition of metadata for the plurality of content of interest comprises providing a list of content of interest URLs to an operating system (OS).

In example 16, the subject matter of examples 11-15 can optionally include wherein the fetching of the metadata for the plurality of content of interest comprises opportunistically requesting resources for establishing a data connection; in response to establishing the data connection, accessing metadata based on tuning parameters determined for one of the plurality of content of interest; and extracting metadata for the one of the plurality of content of interest.

In example 17, the subject matter of examples 11-16 can optionally include wherein the operations further comprise extracting metadata for any of the plurality of content of interest having a same transport stream identifier (TSID) as that of the one of the plurality of content of interest.

In example 18, the subject matter of examples 11-17 can optionally include wherein the operations further comprise determining from a manifest that a piece of over-the-top (OTT) content of interest of the plurality of content of interest is live; in response to the determining that the piece of OTT content of interest is live, waiting a manifest refresh period of time before fetching updated metadata for the piece of content of interest; and fetching the updated metadata after waiting the manifest refresh period of time.

In example 19, the subject matter of examples 11-18 can optionally include wherein the operations further comprise waiting a broadcast refresh period of time before fetching updated metadata for a piece of broadcast content of the plurality of content of interest; and fetching the updated metadata after waiting the broadcast refresh period of time.

Example 20 is a machine-storage medium for optimizing content change. The machine-storage medium configures one or more processors to perform operations comprising monitoring, in real-time, user interactions with a content access page presented on a viewing device; based on the real-time user interactions, determining a plurality of content of interest; triggering acquisition of metadata for the plurality of content of interest determined based on the real-time user interactions, the metadata comprising preconditions for the display of a selected piece of content; fetching the metadata for one or more of the plurality of content of interest; and caching the metadata for the one or more of the plurality of content of interest, the metadata in the cache being immediately available in response to a selection of a piece of content associated with the metadata in the cache for viewing.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A method comprising:
monitoring, in real-time using one or more hardware processors, user interactions with a content access page presented on a viewing device;
based on the real-time user interactions, determining, by one or more hardware processors, a plurality of content of interest comprising both multicast and unicast content that potentially will be a next content for viewing;
determining that a delivery channel associated with a first content of interest of the plurality of content of interest is multicast resulting in the first content of interest being multicast content and that a delivery channel associated with a second content of interest of the plurality of content of interest is unicast resulting in the second content of interest being unicast content;
based on the first content of interest being multicast content, prefetching a first type of metadata corresponding to multicast content for the first content of interest;
based on the second content of interest being unicast content, prefetching a second type of metadata corresponding to unicast content for the second content of interest, the first type and the second type of metadata being different types of metadata that comprise preconditions for rendering and display of the corresponding piece of content without including any portion of the corresponding piece of content, the prefetching of the first and second types of metadata occurring prior to a selection of the next content for viewing; and
caching, in a cache, the first type of metadata and the second type of metadata for the first content of interest and the second content of interest, the first type of metadata and the second type of metadata in the cache being immediately available in response to a selection of the first content of interest or the second content of interest for viewing.

2. The method of claim 1, wherein:
the monitoring comprises detecting a navigational input on the content access page; and
the determining the plurality of content of interest comprises selecting a next n number of content in a direction of the navigational input as the plurality of content of interest.

3. The method of claim 1, wherein:
the content access page comprises a favorites grid; and
the determining the plurality of content of interest comprises selecting every content on the favorites grid as the plurality of content of interest.

4. The method of claim 1, wherein:
the content access page comprises a favorites grid; and
the determining the plurality of content of interest comprises selecting a top number of content on the favorites grid as the plurality of content of interest.

5. The method of claim 1, wherein:
the first type of metadata comprises one or more of a program map table (PMT), a program association table (PAT), a conditional access table (CAT), or a network information table (NIT); and
the second type of metadata comprises one or more of a manifest, a play list, or a license.

6. The method of claim 1, wherein the prefetching of the first and second types of metadata for the plurality of content of interest comprises providing a list of content of interest Uniform Resource Locators (URLs) to an operating system (OS).

7. The method of claim 1, wherein the prefetching of the first and second types of metadata for the plurality of content of interest comprises:
opportunistically requesting resources for establishing a data connection;
in response to establishing the data connection, accessing the first type of metadata based on tuning parameters determined for one of the plurality of content of interest; and
extracting the first type of metadata for the one of the plurality of content of interest.

8. The method of claim 7, further comprising extracting the first type of metadata for any of the plurality of content of interest having a same transport stream identifier (TSID) as that of the one of the plurality of content of interest.

9. The method of claim 1, further comprising:
determining from a manifest that a piece of over-the-top (OTT) content of interest of the plurality of content of interest is live;
in response to the determining that the piece of OTT content of interest is live, waiting a manifest refresh period of time before fetching updated second type of metadata for the piece of content of interest; and
fetching the updated second type of metadata after waiting the manifest refresh period of time.

10. The method of claim 1, further comprising:
waiting a broadcast refresh period of time before fetching updated first type of metadata for a piece of broadcast content of the plurality of content of interest; and
fetching the updated first type of metadata after waiting the broadcast refresh period of time.

11. A system comprising:
one or more hardware processors; and
a memory storing instructions, that when executed by the one or more hardware processors, cause the one or more hardware processors to perform operations comprising:
monitoring, in real-time, user interactions with a content access page presented on a viewing device;
based on the real-time user interactions, determining a plurality of content of interest comprising both multicast and unicast content that potentially will be a next content for viewing:
determining that a delivery channel associated with a first content of interest of the plurality of content of interest is multicast resulting in the first content of interest being multicast content and that a delivery channel associated with a second content of interest of the plurality of content of interest is unicast resulting in the second content of interest being unicast content;
based on the first content of interest being multicast content, prefetching a first type of metadata corresponding to multicast content for the first content of interest;
based on the second content of interest being unicast content, prefetching a second type of metadata corresponding to unicast content for the second content of interest, the first type and the second type of metadata being different types of metadata that comprise preconditions for rendering and display of the corresponding piece of content without including any portion of the corresponding piece of content, the prefetching of the first and second types of metadata occurring prior to a selection of the next content for viewing: and
caching, in a cache, the first type of metadata and the second type of metadata for the first content of interest and the second content of interest, the first content of interest and the second metadata in the cache being immediately available in response to a selection of the first content of interest or the second content of interest for viewing.

12. The system of claim 11, wherein:
the monitoring comprises detecting a navigational input on the content access page; and
the determining the plurality of content of interest comprises selecting a next n number of content in a direction of the navigational input as the plurality of content of interest.

13. The system of claim 11, wherein:
the content access page comprises a favorites grid; and
the determining the plurality of content of interest comprises selecting every content on the favorites grid as the plurality of content of interest.

14. The system of claim 11, wherein:
the content access page comprises a favorites grid; and
the determining the plurality of content of interest comprises selecting a top number of content on the favorites grid as the plurality of content of interest.

15. The system of claim 11, wherein the prefetching of the first and second types of metadata for the plurality of content of interest comprises providing a list of content of interest Uniform Resource Locators (URLs) to an operating system (OS).

16. The system of claim 11, wherein the prefetching of the first and second types of metadata for the plurality of content of interest comprises:
opportunistically requesting resources for establishing a data connection;
in response to establishing the data connection, accessing the first type of metadata based on tuning parameters determined for one of the plurality of content of interest; and
extracting the first type of metadata for the one of the plurality of content of interest.

17. The system of claim 16, wherein the operations further comprise extracting the first type of metadata for any of the plurality of content of interest having a same transport stream identifier (TSID) as that of the one of the plurality of content of interest.

18. The system of claim 11, wherein the operations further comprise:
determining from a manifest that a piece of over-the-top (OTT) content of interest of the plurality of content of interest is live;
in response to the determining that the piece of OTT content of interest is live, waiting a manifest refresh period of time before fetching updated second type of metadata for the piece of content of interest; and
fetching the updated second type of metadata after waiting the manifest refresh period of time.

19. The system of claim 11, wherein the operations further comprise:
waiting a broadcast refresh period of time before fetching updated first type of metadata for a piece of broadcast content of the plurality of content of interest; and
fetching the updated first type of metadata after waiting the broadcast refresh period of time.

20. A non-transitory machine-storage medium storing instructions that when executed by one or more hardware processors of a machine, cause the machine to perform operations comprising:
monitoring, in real-time, user interactions with a content access page presented on a viewing device;
based on the real-time user interactions, determining a plurality of content of interest, comprising both multicast and unicast content;
determining that a delivery channel associated with a first content of interest of the plurality of content of interest is multicast resulting in the first content of interest being multicast content and that a delivery channel associated with a second content of interest of the plurality of content of interest is unicast resulting in the second content of interest being unicast content;
based on the first content of interest being multicast content, prefetching a first type of metadata corresponding multicast content for the first content of interest;
based on the second content of interest being unicast content, prefetching a second type of metadata corresponding to unicast content for the second content of interest, the first type and the second type of metadata being different types of metadata that comprise preconditions for rendering and display of the corresponding piece of content without including any portion of the corresponding piece of content, the prefetching of the first and second types of metadata occurring prior to a selection of the next content for viewing: and
caching, in a cache, the first type of metadata and the second type of metadata for the first content of interest and the second content of interest, the first content of interest and the second metadata in the cache being immediately available in response to a selection of the first content of interest or the second content of interest for viewing.
